(19) United States
(12) Patent Application Publication
(10) Pub. No.: US 2003/0066404 A1
(43) Pub. Date: Apr. 10, 2003

(54) Ring and pinion driven circular saw blade

(76) Inventor: John Frank Giwojna, Thorp, WI (US)

Correspondence Address: John Giwojna, c/o Greg Strasser, 407 Sturgeon Eddy, Wausau, WI, 54402, US

(21) Appl. No.: 09/971,276

(22) Filed: Oct. 5, 2001

(51) Int. Cl. B23D 47/12

(52) U.S. Cl. 83/591; 83/835; 83/676

(57) ABSTRACT

This invention provides a new and more efficient drive system for a circular saw blade. The invention is comprised of a circular saw blade with a ring gear built into the blade. It is driven by a matching pinion gear. The invention provides a means to employ the typical cutting capabilities of a circular saw blade but with certain unique advantages. The ring and pinion drive allows for better balance in that the motor that drives the saw blade can be located at the rear of the saw blade, as opposed to the side of the blade as it is with conventional circular saws. This configuration also allows for greater cutting depth. The ring and pinion drive also allows for a smaller motor and a resulting lower cutting speed that, in turn, cuts down on dust emission.

### BACKGROUND OF THE INVENTION

The present invention relates to power cutting tools. It specifically relates to circular saws. Usually, circular saws employ an electric motor which drives a circular saw blade from the side by means of a drive shaft running from the motor and through the center or hub of the circular saw blade. This results in a heavy, hard to guide and balance saw. It also limits the cutting depth of the blade and the ability to slow the cutting speed to reduce dust emission.

Prior art demonstrates that little if anything has been done to address these problems. This is because of the restrictions inherent in a center gear driven blade. As long as a center gear driven blade is used, the motor must be placed off to the side of the blade meaning that a relatively heavy motor must be balanced while cutting. In addition, the cutting depth of the blade is limited by the location of the shaft and attending speed-reducing gears at the center of the blade. In addition, the ability to reduce the speed of the blade is limited by the need to keep speed reducing gears smaller to maintain cutting depth. Because the speed of the blade cannot be reduced, the volume of dust produced by the cutting process cannot be reduced.

The present invention allows for all of the advantages of a conventional center driven circular saw blade. However, it also allows for other unique advantages. The ring and pinion circular saw blade drive system allows for the placement of the motor behind the saw. This makes it easier to balance and guide the saw blade. It also makes it easier to see the cutting line. The ring and pinion drive system also makes more efficient use of the power provided by the electric motor. This is because the ring and pinion drive system applies torque directly from a pinion on the shaft of an electric motor to ring holes cut into a circular saw blade. By contrast, a conventional style circular saw applies power to a speed reduction gear such that the shaft of the electric motor is offset from the center of the blade. The use of the ring and pinion direct drive also allows for a smaller motor, and precludes the need for speed reducing gears, all of which, in turn, reduces the weight of the saw.

### SUMMARY OF THE INVENTION

The present invention is designed to correct the problems outlined above, as they pertain to prior art. The present invention employs a new and revolutionary drive system for a circular saw blade by employing a ring and pinion drive system instead of a conventional center shaft driven blade.

The present invention consists of a circular saw blade with a ring gear built into the blade. This is done by cutting oval shaped holes in the blade along the inner diameter of the blade. The holes are equally spaced in distance from each other and are oriented such that they will accept the sprockets from a pinion gear placed in parallel fashion to the blade. This matching pinion gear drives the saw blade by means of the pinion holes in the blade.

The pinion gear is molded to the metal shaft of an electric AC/DC fractional horsepower motor. As a result, the pinion gear is driven directly by the electrical motor and thus directly applies the power of that motor to the circular saw blade by means of the ring gears in the blade.

It is thus the objective of the present invention to employ a new system for driving a circular saw blade thereby allowing for greater ease of control of the saw due to the position of the electrical motor behind the saw and the reduced size (and corresponding reduced weight) of the motor required to drive the blade. It also provides for greater cutting depth due to the arrangement of the power transmission to the blade. It also makes it easier to follow a cutting line. The ring and pinion drive also allows for a smaller motor and a resulting lower cutting speed. This, in turn, cuts down on dust emission

### BRIEF DESCRIPTION OF THE DRAWING

FIG. 1 is a perspective drawing of the present ring and pinion drive system for a circular saw blade.

### DETAILED DESCRIPTION OF THE PREFERRED EMBODIMENT

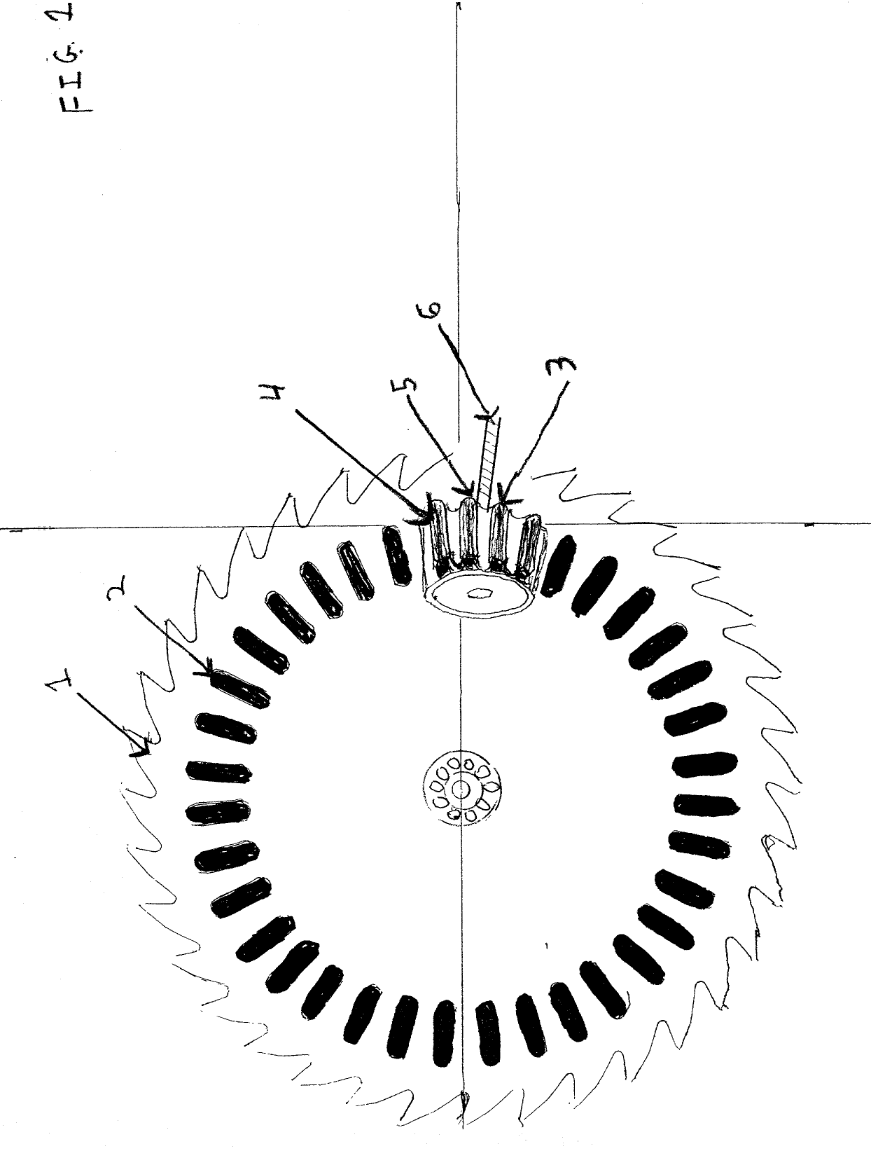

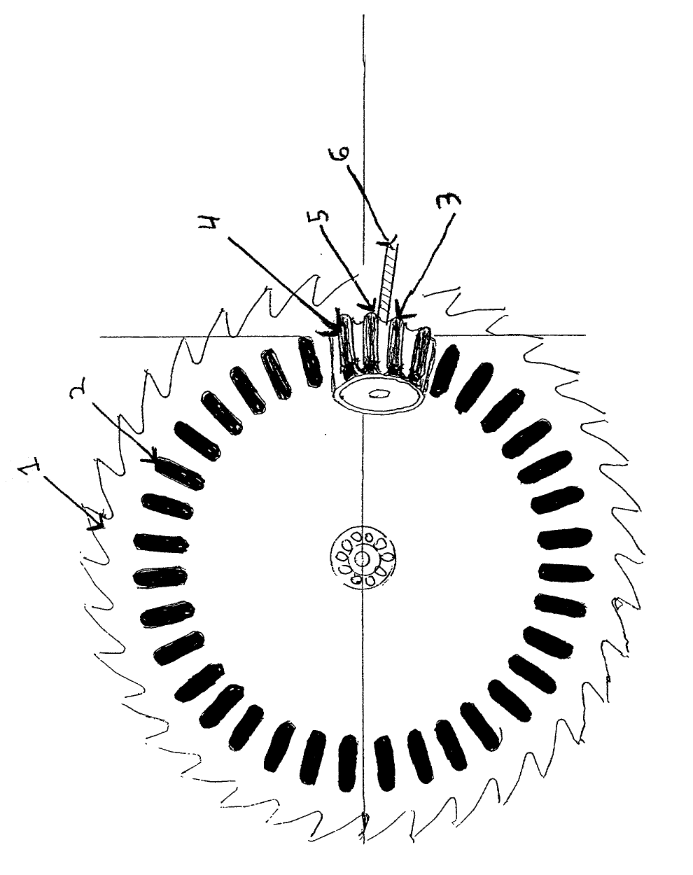

Referring to the drawings, more particularly by reference numbers, wherein like numerals refer to like parts, FIG. 1 is a perspective drawing of the present ring and pinion driven circular saw blade system.¹ ¹It is respectfully requested that the drawings being submitted herewith be accepted at this time as temporary drawings only. Proper drawings will be submitted, as required by the examiner.

Number 1 in FIG. 1 identifies a standard circular saw blade. Number 2 identifies a ring gear device (oval holes) cut into the circular saw blade 1, equally spaced along the outer diameter of the blade 1, just below the teeth of the blade and according to the teachings of the present invention. Number 3 identifies a matching pinion gear device constructed according to the teachings of the present invention. Number 4 identifies the place where the teeth of the ring gear device 3 meet and mesh with the holes of the pinion gear device. Number 5 identifies the point where the pinion gear device 3 is molded to a metal shaft Number 6. Number 6 identifies the metal shaft.

Applying a device like an electrical motor to drive the metal shaft 6 causes the pinion gear 5 to rotate. The rotation of the pinion gear 5 causes rotation of the circular saw blade 1 by means of the rotation of the teeth of the pinion gear 5 where they mesh with the holes of the ring gear 4 cut into the circular saw blade 1. This provides a drive mechanism for the circular saw blade 1.

What is claimed:

1. A ring and pinion drive system for a circular saw blade comprising:
A circular saw blade with a ring gear device (oval holes) cut into the outer diameter of the circular saw blade just below the teeth of the blade according to the teachings of the present invention:
A matching pinion gear device molded to a metal shaft to which power is applied, thus causing rotation of the teeth of the pinion gear where those teeth mesh with the holes of the ring gear holes cut into the circular saw blade thereby providing a drive mechanism for the circular saw blade.
